(19) United States
(12) Patent Application Publication
(10) Pub. No.: US 2009/0192889 A1
(43) Pub. Date: Jul. 30, 2009

(54) SYSTEM AND METHOD FOR PREVENTING UNAUTHORIZED CONTACT OF APPLICANTS

(75) Inventors: Andrew Lukes, Lone Tree, CO (US); Ran Margalit, Boulder, CO (US)

Correspondence Address: HOVEY WILLIAMS LLP, 10801 Mastin Blvd., Suite 1000, Overland Park, KS, 66210, US

(73) Assignee: Market Genomics, LLC, Englewood, CO (US)

(21) Appl. No.: 12/021,779

(22) Filed: Jan. 29, 2008

(51) Int. Cl. G06Q 30/00; G06Q 99/00

(52) U.S. Cl. 705/14; 705/1

(57) ABSTRACT

A system and method for preventing unauthorized use of sales leads. Application information is gathered from an applicant after the applicant views an Internet ad or other advertisement. The application information may include the applicant's e-mail address and phone number. At least one pseudo e-mail address or phone number is then created that identifies at least some of the application information and a potential purchaser of the application information. A unique pseudo e-mail address or phone number is created for each potential purchaser of the application information. The pseudo e-mail addresses or phone numbers and at least some of the application information are then provided to potential purchasers of the application information. Any communications sent using the pseudo e-mail addresses or phone numbers are initially directed to a mail server or phone system operated by or under the control of the entity that placed the advertisement. If a potential purchaser attempts to contact an applicant with the pseudo e-mail address or phone number without first paying for the application information, the e-mail or phone call is sent to the entity which generated the lead, not the applicant. Once a potential purchaser purchases the application information, communications made by the potential purchaser using the pseudo e-mail address are forwarded to the applicant's actual e-mail address.

### FIELD

The present invention relates to sales leads generated on the Internet. More particularly, the invention relates to a system and method for preventing the unauthorized use of sales leads.

### BACKGROUND

Because most information available on the Internet is free, many website operators, search engine providers, and browser providers generate most of their revenue by selling advertising space for “pop-up” ads and banner ads. One type of Internet advertising attempts to gather “leads” from applicants, which are then sold to businesses that attempt to sell products or services to the applicants. For example, an Internet advertisement may invite Internet users to “Click Here If You Want To Refinance Your Home at a Lower Rate!”. After clicking on or otherwise selecting the ad, the user (or applicant) is directed toward a template which requests the user's name, contact information, financial information, etc. After gathering this information, the entity that sponsored the ad attempts to sell the lead to mortgage companies, brokers, etc. Once the lead has been purchased, the purchasing entity may contact the applicant and offer him or her a loan.

Hundreds or even thousands of leads may be generated from an Internet advertisement and then offered to numerous potential purchasers (typically one at a time so the same lead is not sold to more than one entity). Although most potential purchasers purchase the leads before contacting the applicants, many unscrupulous ones use the leads without paying for them. This forces the generator of the leads to charge more to offset the lost revenue and decreases the value of the leads to honest purchasers because the applicants may be contacted by entities who stole the leads before the honest purchasers can reach them.

One way to prevent theft of leads is to provide the applicants' contact information only after the leads have been purchased, but this solution is only partially effective because an applicant's contact information can often be gleaned from other provided information. Moreover, this solution adds another step to the process and therefore makes it more time-consuming and difficult to sell the leads. Because many applicants purchase Internet-advertised products or services impulsively and solicit quotes from multiple vendors, any delay in contacting the applicants decreases the likelihood of making a sale.

### SUMMARY

The present invention solves the above-described problems and provides a distinct advance in the art of Internet advertising and other types of advertising. More particularly, embodiments of the invention provide a system and method for preventing unauthorized use of sales leads.

In one exemplary embodiment, application information is gathered from an applicant after the applicant views an Internet ad or other advertisement. The application information may include the applicant's e-mail address, phone number, and any information that may be useful to evaluate the applicant's ability to purchase products or services. For example, if the Internet ad relates to a mortgage solicitation, the application information may include the applicant's income and other financial information.

At least one pseudo e-mail address or phone number is then created that identifies at least some of the application information and a potential purchaser of the application information. Importantly, a unique pseudo e-mail address or phone number is created for each potential purchaser of the application information.

The pseudo e-mail addresses or phone numbers and at least some of the application information are then provided to potential purchasers of the application information. Any communications sent using the pseudo e-mail addresses or phone numbers are initially directed to a mail server or phone system operated by or under the control of the entity that placed the advertisement. If a potential purchaser attempts to contact an applicant without first paying for the application information, the e-mail or phone call is sent to the entity which generated the information, not the applicant. Once a potential purchaser purchases the application information, communications made by the potential purchaser using the pseudo e-mail address are forwarded to the applicant's actual e-mail address. Thus, honest purchasers of the application information can contact applicants without delay, but persons or entities that attempt to contact applications without paying for the application information are thwarted.

These and other important aspects of the invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a schematic diagram of exemplary computer and communications equipment that may be used to implement embodiments of the invention.

FIG. 2 shows an exemplary database that may be generated by the equipment of FIG. 1.

FIG. 3 shows another exemplary database that may be generated by the equipment of FIG. 1.

FIG. 4 is a flow diagram illustrating certain steps of an exemplary method of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

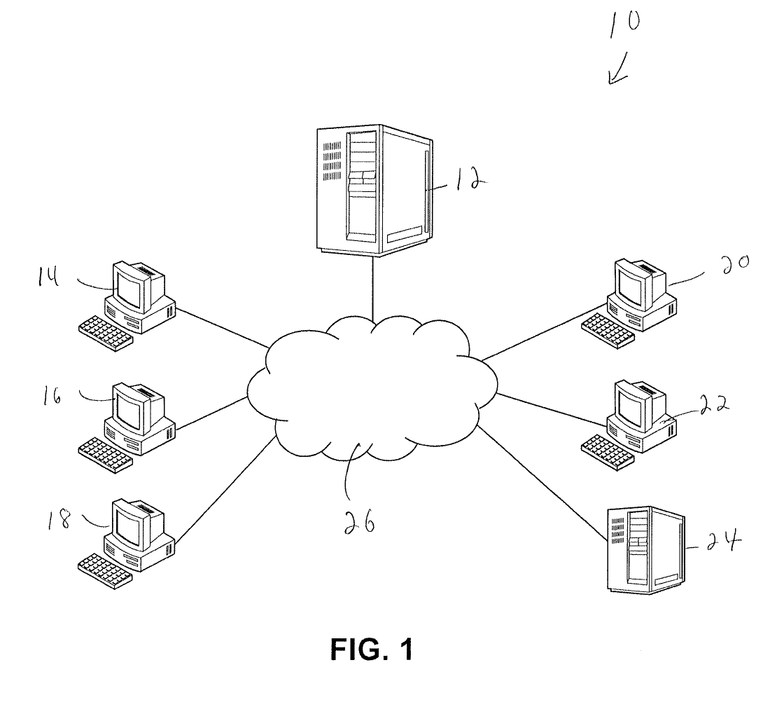

Embodiments of the invention can be implemented in hardware, software, firmware, or a combination thereof. In an exemplary embodiment, the invention is implemented with computer and communications equipment broadly referred to by the numeral 10 in FIG. 1. The equipment 10 broadly includes a mail server 12 and a plurality of computing devices 14, 16, 18, 20, 22, 24 that may access the mail server 12 via a communications network 26. The computer and communications equipment 10 illustrated and described herein are merely examples of equipment that may be used to implement embodiments of the present invention and may be replaced with other computer and communications equipment without departing from the scope of the appended claims. Moreover, any number of mail servers 12 and computing devices 14-24 may be provided.

The mail server 12 serves as a repository for data and computer programs used to implement certain aspects of the invention. The mail server 12 may be operated by an entity that places advertisements on the Internet or elsewhere or may be operated by an entity that provides support services to multiple entities that place Internet advertising.

The mail server 12 may be any computing device such as a network computer running Windows, Novel, Unix, Cisco, or any other network operating system. The mail server 12 may be connected to other computing devices that serve as firewalls to prevent tampering with information stored on or accessible by the mail server 12 and to other computing devices operated by administrators. The mail server 12 operates a conventional mail transfer agent (MTA) program to receive and transfer electronic mail (e-mail) between the computing devices 14-24 and other computers. The mail server includes conventional web hosting operating software, an Internet connection such as a modem, DSL converter or ISDN converter, and is assigned a URL and corresponding domain name such as “secureinfo.com” so that it can be accessed via the Internet in a conventional manner.

The mail server 12 or a computer attached to or in communication with the mail server may implement a computer program for performing functions as described herein. The computer program may comprise an ordered listing of executable instructions for implementing logical functions in the mail server 12 and/or the computing devices 14-24. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The computing devices 14-24 may be any types of devices that permit access to the mail server 12 via the communications network 26. For example, the computing devices may include personal computers such as those manufactured and sold by Dell, Compaq, Gateway, or any other computer manufacturer, handheld personal assistants such as those manufactured and sold by Palm or Pilot, or even Internet appliances that are specifically designed for accessing the Internet. Each computing device 14-24 preferably includes or can access a conventional Internet connection such as a modem, DSL converter, or ISDN converter and a web browser that permits it to access the Internet.

Some of the computing devices, such as devices 14, 16, 18, may be used by persons who wish to learn more about the products or services offered by companies or who wish to apply for or purchase products or services. For example, in some embodiments, one of the computing devices 14, 16, 18 may be operated by a person wishing to receive a quote for a home or car loan, an estimate for a house remodeling project, a quote for home or car insurance, or information about any other product or service. Such persons are also referred to herein as “applicants.”

Similarly, some of the computing devices, such as the devices 20, 22, 24, may be operated by companies or other entities that provide products or services to the applicants and other consumers. For example, in some embodiments, one of the computing devices 20, 22, 24 may be operated by an entity offering home loans, car loans, remodeling services, home insurance, or car insurance. The entities operating the computers 20, 22, 24 are potential purchasers of the application information or leads discussed herein and are therefore referred to as “potential purchasers.”

The communications network 26 is preferably the Internet but may be any other conventional communications network such as a local area network, a wide area network, a wireless network, or an intranet.

The above-described computer and communications equipment 10 may be used or operated as follows. In one exemplary embodiment, an entity wishing to generate and sell leads may place a pop-up ad or banner ad on a website, browser, or search engine. The ad may, for example, target consumers looking for a home loan, car loan, or payday loan. An Internet user operating one of the computers 14, 16, 18 may then click on or otherwise select the advertisement. The mail server 12 or some other computing device may then direct the Internet user to a template which requests application information. The application information may include the applicant's e-mail address, phone number, and any information that may be useful to evaluate the applicant's ability or desire to purchase products or services. For example, if the Internet ad relates to a mortgage solicitation, the application information may include the applicant's income and other financial information. The mail server 12 or some other computing device then stores the application information as a sales lead.

A number of potential purchasers of the sales lead are then identified. This may be done automatically by the mail server 12 or other computing device or manually by a person working for the entity which placed the ad. For the mortgage advertisement example, the potential purchasers may include several banks, mortgage brokers, and other financial institutions. The potential purchasers may be selected based on the relevancy of the application information. For example, if the application information relates to a home remodeling project in Kansas City, Mo., the selected potential purchasers may all be contractors located within a specified distance from Kansas City, Mo.

Pseudo e-mail addresses or phone numbers are then created for each of the potential purchasers. Each of the pseudo e-mail addresses or phone numbers identifies at least some of the application information and a potential purchaser of the application information. The pseudo e-mail addresses or phone numbers are then linked or otherwise associated with the applicant's actual e-mail address or phone number. The linked information is then stored in the mail server 12 or in another device accessible by the mail server.

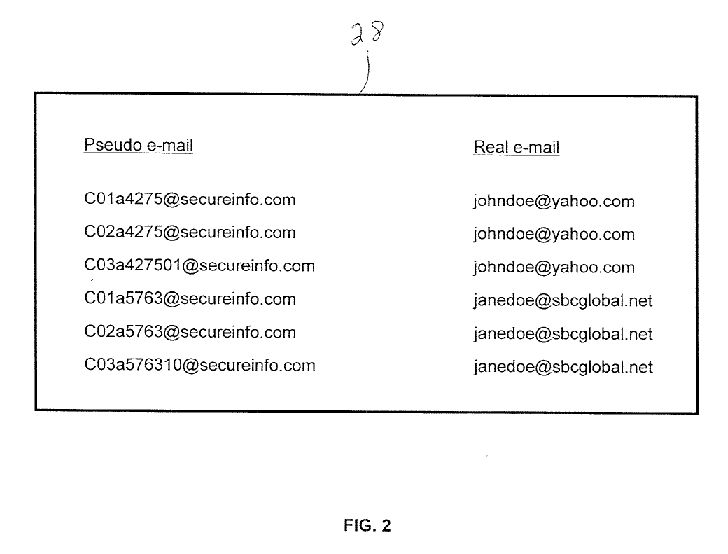

FIG. 2 shows an exemplary database 28 of linked information that may be stored in or accessible by the mail server 12. The first column lists the pseudo e-mail addresses generated for a number of potential purchasers of application information. Each of the pseudo e-mail addresses includes information that identifies an applicant or application information and a specific potential purchaser. For example, the pseudo e-mail address “C01a4275@secureinfo.com” listed in the first line of FIG. 2 may refer to a potential purchaser identified as “C01” (or customer number one) and an applicant or application number “a4275.” Similarly, the pseudo e-mail address “C02a4275@secureinfo.com” listed in the second line of FIG. 2 may refer to a potential purchaser “C02” (or customer number two) and an applicant or application number of “a4275.” The pseudo e-mail addresses listed in the fourth and fifth lines of FIG. 2 relate to the same potential purchasers C01 and C02 but a different applicant or application number “a5763.”

The pseudo e-mail addresses listed in the third and sixth lines of FIG. 2 include two additional digits after the applicant or application number. These digits may be used by a potential purchaser who re-sells leads to sub-purchasers. The potential purchaser may use these additional digits to identify the sub-purchasers. For example, the pseudo e-mail address “C03a427501@secureinfo.com” listed in the third line of FIG. 2 may refer to potential purchaser “C03,” applicant or application number “a4275,” and sub-purchaser “01.” Similarly, the pseudo e-mail address “C03a576310@secureinfo.com” listed in the sixth line of FIG. 2 may refer to potential purchaser “C03,” applicant or application number “a5763,” and sub-purchaser “10.”

The second column of FIG. 2 lists the actual e-mail addresses for the applicants. For example, the e-mail address “johndoe@yahoo.com” in line one is the e-mail address for the applicant corresponding to application number “a4275.” The second column may also list additional contact information for the applicant.

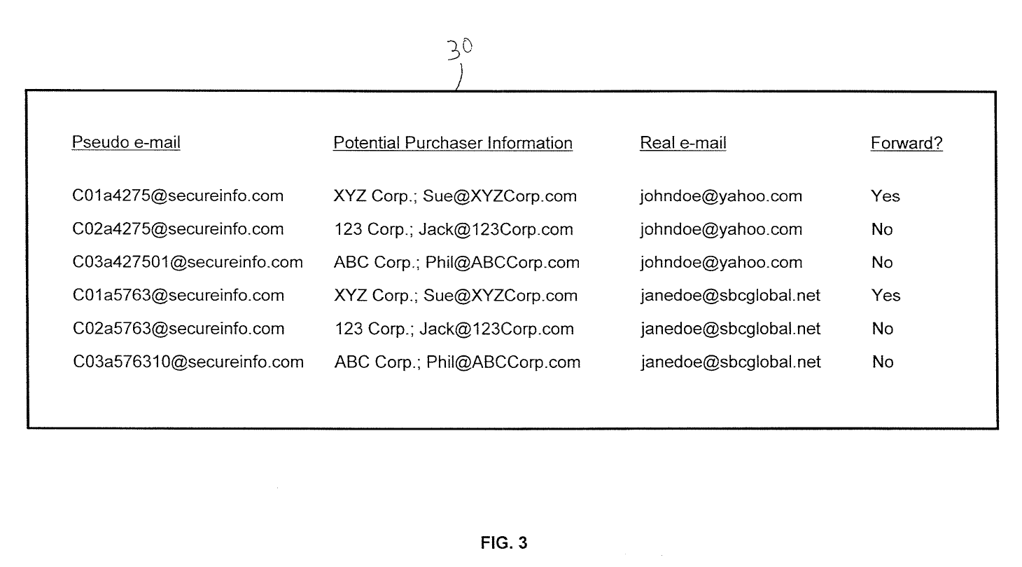

FIG. 3 shows another exemplary database 30 including additional linked information. The first and third columns of the database 30 are the same as the first and second columns, respectively, of the database 28. The second column of database 30 includes contact information and possibly other information for the potential purchasers. For example, potential purchaser “CO I” identified in the first line of FIG. 3 may be the XYZ Corp. and have a contact person named “Sue” with an e-mail address of “sue@xyzcorp.com.” The fourth column of database 30 is a field that indicates whether communication sent to the pseudo e-mail address should be forwarded to the applicant's real e-mail address. For example, e-mails sent to “C01a4275@secureinfo.com” will be forwarded to “johndoe@yahoo.com” but e-mails sent to “C02a4275@secureinfo.com” by the 123 Corp. will not be forwarded.

The information in the databases of FIG. 2 and FIG. 3 is linked or otherwise associated. For example, the pseudo e-mail address in line one, column one of FIG. 2 is linked with the real e-mail address in line one, column two of FIG. 2. The information may be linked in any conventional manner. The databases shown in FIGS. 2 and 3 are merely examples of how the pseudo e-mail addresses and application information may be linked. The information does not necessarily have to be stored in the same database to be linked.

Other pseudo contact information may also be created instead of the pseudo e-mail addresses. For example, the pseudo and actual e-mail addresses listed in FIGS. 2 and 3 may be replaced with pseudo and actual phone numbers.

The pseudo e-mail addresses or phone numbers and at least some of the application information are then provided to the potential purchasers. For example, if Sue at the XYZ Corp. is operating computing device 20, the operator or other agent of the mail server 12 may send Sue a lead (or application information) for applicant “a4275” along with the pseudo e-mail address “C01a4275@secureinfo.com.” Sue may then evaluate the application information to determine if her company would like to purchase the application information or lead. Any communications sent by Sue using the pseudo e-mail address or phone number are initially directed to the mail server 12 or a phone system operated by or under the control of the entity that placed the advertisement. If XYZ Corp. attempts to contact applicant “a4275” with the pseudo e-mail address or phone number without first paying for the application information, the operator of the mail server or phone system will receive the communication and know that XYZ Corp. is trying to steal the lead. The generator of the lead may then take appropriate action such as contacting XYZ Corp., removing the company from the list of potential purchasers, etc.

However, if XYZ Corp. purchases the application information, all communications directed to the pseudo e-mail address or phone number are forwarded to the applicant's actual e-mail address. Thus, honest purchasers of the application information can contact applicants without delay, but persons or entities that attempt to contact applications without paying for the application information are thwarted.

The mail server 12 or other computing device may also generate reports or alerts that identify attempted thefts of the leads. For example, a weekly (or daily, monthly, etc.) report may be generated which lists all the potential purchasers and the number of times they each attempted to contact applicants without paying for the application information.

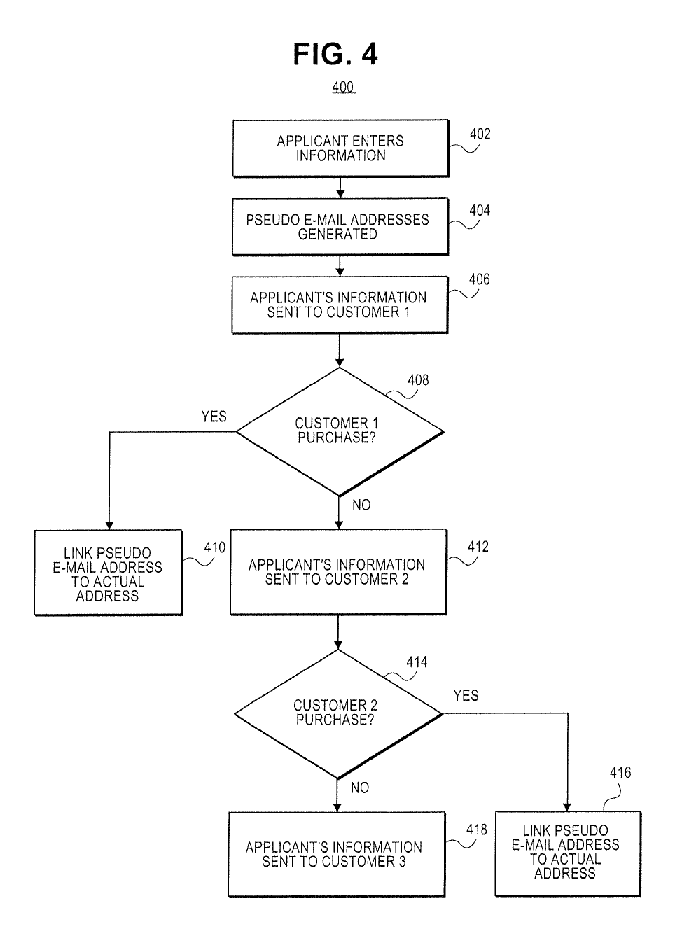

The flow chart of FIG. 4 shows the functionality and operation of an exemplary embodiment in more detail. Some of the blocks of the flow chart may represent a module segment or portion of computer program code which comprises one or more executable instructions for implementing the specified logical function or functions. In some alternative implementations, the functions noted in the various blocks may occur out of the order depicted in FIG. 4. For example, two blocks shown in succession in FIG. 4 may in fact be executed substantially concurrently, or the blocks may sometimes be executed in the reverse order depending upon the functionality involved.

In step 402, an applicant enters application information into a template or other form. This may be done in response to an Internet solicitation or other advertisement. For example, as discussed above, an Internet user wishing to refinance his or her home may respond to a mortgage solicitation and provide information necessary to apply for a loan.

In step 404, a pseudo e-mail address is generated for each potential purchaser of the application information gathered in step 402. The pseudo e-mail address for each potential purchaser may then be linked with the application information as discussed in more detail above.

In step 406, at least some of the applicant's information is sent to a first customer or potential purchaser. If the first customer purchases the information in step 408, step 410 links the pseudo e-mail address given to the first customer with the actual e-mail address of the applicant. The first customer may then contact the applicant and allow the applicant to apply for a loan. If the first customer does not purchase the information, any attempts to reach the applicant using the pseudo e-mail address will be ineffective.

If the first customer does not elect to purchase the application information, the information is then sent to a second customer in step 412. If the second customer purchases the information in step 414, step 416 links the pseudo e-mail address given to the second customer with the actual e-mail address of the applicant. The second customer may then contact the applicant and allow the applicant to apply for a loan. If the second customer does not purchase the information, any attempts to reach the applicant using the pseudo e-mail address will be ineffective.

If the second customer does not elect to purchase the application information, the information is then sent to a third customer in step 418. These steps are repeated until a potential purchaser purchases the application information or the generator of the information quits trying to sell it. Reports or alerts may also be generated as mentioned above.

Although the invention has been described with reference to the preferred embodiment illustrated in the attached drawing figures, it is noted that equivalents may be employed and substitutions made herein without departing from the scope of the invention as recited in the claims. For example, although embodiments of the invention are particularly useful for generating and selling leads from Internet advertising, the leads may also be generated from other types of advertising such as newspaper ads, direct marketing, etc. Moreover, although applicants are contacted by e-mail in some embodiments, they may also be contacted by pseudo phone numbers or other contact designators.

Having thus described the preferred embodiment of the invention, what is claimed as new and desired to be protected by Letters Patent includes the following:

1. A method for preventing unauthorized contact of applicants, the method comprising the steps:
gathering application information from an applicant;
creating at least one contact designator that identifies the applicant and a potential purchaser of the application information;
providing the contact designator and at least some of the application information to the potential purchaser;
once the potential purchaser has been authorized to contact the applicant, forwarding communications made by the potential purchaser using the contact designator to the applicant; and
if the potential purchaser has not been authorized to contact the applicant, preventing communications made by the potential purchaser with the contact designator from reaching the applicant.

2. The method as set forth in claim 1, further including the step of monitoring receipt of communications made using the contact designator to determine if the potential purchaser is attempting to contact the applicant without first purchasing the application information.

3. The method as set forth in claim 1, wherein the application information includes an e-mail address, phone number, or postal address of the applicant.

4. The method as set forth in claim 1, wherein the contact designator is a pseudo e-mail address, a pseudo phone number, or a pseudo postal address.

5. The method as set forth in claim 1, further including the step of placing an advertisement on an Internet website, browser, or search engine to solicit the application information from the applicant.

6. The method as set forth in claim 1, further including the steps of creating multiple contact designators, each of which identifies at least some of the application information and a specific potential purchaser, and then providing the contact designators and at least some of the application information to multiple potential purchasers.

7. The method as set forth in claim 1, wherein the potential purchaser is an entity which sells products or services to consumers.

8. The method as set forth in claim 7, wherein the applicant is a potential consumer of the products or services of the entity.

9. The method as set forth in claim 1, further including the step of linking the application information, the contact designator, and contact information for the potential purchaser in a database.

10. A method for preventing unauthorized contact of applicants, the method comprising the steps:
gathering application information from an applicant, the application information including the applicant's e-mail address;
creating at least one pseudo e-mail address that identifies at least some of the application information and a potential purchaser of the application information;
providing the pseudo e-mail address and at least some of the application information to the potential purchaser; and
if the potential purchaser purchases the application information, forwarding communications made by the potential purchaser using the pseudo e-mail address to the applicant's e-mail address.

11. The method as set forth in claim 10, further including the step of monitoring receipt of communications made using the pseudo e-mail address to determine if the potential purchaser is attempting to contact the applicant without first purchasing the application information.

12. The method as set forth in claim 10, wherein the potential purchaser is an entity which sells products or services to consumers.

13. The method as set forth in claim 12, wherein the applicant is a potential consumer of the products or services of the entity.

14. The method as set forth in claim 10, further including the step of linking the application information, the pseudo e-mail address, and contact information for the potential purchaser in a database.

15. The method as set forth in claim 10, further including the step of placing an advertisement on an Internet website, browser, or search engine to solicit the application information from the applicant.

16. The method as set forth in claim 10, further including the steps of creating multiple pseudo e-mail addresses, each of which identifies at least some of the application information and a separate potential purchaser, and then providing the pseudo e-mail addresses and at least some of the application information to multiple potential purchasers.

17. A method for preventing unauthorized contact of applicants, the method comprising the steps:
placing an advertisement on the Internet;
gathering application information from an applicant who views the advertisement, the application information including the applicant's e-mail address;
identifying a plurality of potential purchasers of the application information;
creating a plurality of pseudo e-mail addresses for the potential purchasers, each of which identifies at least some of the application information and one of the potential purchasers;
linking the applicant's e-mail address and the pseudo e-mail addresses in a database or other memory structure;
providing the pseudo e-mail addresses and at least some of the application information to the potential purchasers; and
if one of the potential purchasers purchases the application information, forwarding communications made by that potential purchaser using that potential purchaser's pseudo e-mail address to the applicant's e-mail address.

18. The method as set forth in claim 17, further including the step of monitoring receipt of communications made using the pseudo e-mail address to determine if the potential purchaser is attempting to contact the applicant without first purchasing the application information.

19. The method as set forth in claim 17, wherein the application information includes an e-mail address, phone number, or postal address of the applicant.

20. The method as set forth in claim 17, further including the step of generating a report of all unauthorized attempts to contact the applicant.
